(19) United States
(12) Patent Application Publication
(10) Pub. No.: US 2006/0146493 A1
(43) Pub. Date: Jul. 6, 2006

(54) HEAT DISSIPATION MODULE

(76) Inventors: Hsuan-Cheng Wang, Taipei City (TW); Chun-Hung Lin, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,134

(22) Filed: Jul. 25, 2005

(30) Foreign Application Priority Data
Jan. 3, 2005 (TW) 94200020

(51) Int. Cl. G06F 1/20

(52) U.S. Cl. 361/687

(57) ABSTRACT

A heat dissipation module is suited for a portable electronic device. The module includes a first mesh, a housing and a fan, wherein the first mesh disposed at the bottom of the casing of the device has a plurality of first openings. The housing has an air inlet, a second mesh, a mounting space and an air outlet, wherein the second mesh disposed at the top of the housing has a plurality of second openings. The diameter of each of the second openings is smaller than that of the first openings. To satisfy the safety standard, the heat dissipation efficiency of this device can be improved by changing the size of these two openings. Furthermore, the first and second mesh are respectively formed with the bottom of the casing and the top of the housing together as an integral unit to reduce the production cost of the portable electronic device.

### CROSS-REFERENCE TO RELATED APPLICATION

This application claims the priority benefit of Taiwan application serial no. 94200020, filed on Jan. 3, 2005. All disclosure of the Taiwan application is incorporated herein by reference.

### BACKGROUND OF THE INVENTION

1. Field of Invention

The present invention relates to heat dissipation module, and specifically to the heat dissipation module with mesh, which is suited for portable electronic device and used to provide heat dissipation function to the portable electronic device.

2. Description of Related Art

In recent years, computer technology has been greatly and fast improved. In addition to the operation speed of the computer advancing continuously, the heat energy of electronic component of the computer also constantly increases. In order to prevent overheating of the electronic components in the computer, which causes the temporary or permanent malfunction of the electronic component, the common technology will add a heat dissipation module in the computer. This can expel the hot air in the computer to the outside to decrease the computer temperature. It then causes the computer to operate more smoothly. Due to the restriction in the dimension of the notebook, it causes the inner space of the notebook to be narrow. It thus becomes very important to provide the heat dissipation module. In addition, aside from the aforementioned notebook, some portable electronic devices also need to install the heat dissipation module in their inner part to provide heat dissipation function.

Referring to FIG. 1A, it is a cross-sectional drawing of conventional heat dissipation module which is applied to portable electronic device. This conventional heat dissipation module 100 is suited for a portable electronic device, such as notebook. This portable electronic device includes a main module (not shown) and a casing 10, wherein the main module has a motherboard 20 that is installed in the casing 10. In addition, the casing 10 has a first opening 12 and a second opening 14. The first opening 12 is located at the bottom of the casing 10 to serve as an air inlet. The second opening 14 is at lateral location of the casing 10 to serve as an air outlet.

The aforementioned heat dissipation module 100 includes a housing 110 and a fan 120, wherein the fan 120 is installed in the housing 110, and provides the power to propel the air. Referring to FIG. 1A, 1B and 1C, the heat dissipation module 100 also includes a mesh 130 with a plurality of holes 132, which is mounted in the first opening 12 at the bottom of the casing 10 to allow air circulation. FIG. 1B shows that these holes 132 of the mesh 130 are a slit design. And FIG. 1C shows that these holes 132 of the mesh 130 are a circular design.

The housing 110 is installed in the casing 10 and has a first air inlet 112, a second air inlet 114, a mounting space 116 and an air outlet 118. The aforementioned fan 120 is installed in the mounting space 116 of the housing 110. The first air inlet 112 is located at the bottom of the housing 110, and faces against the first opening 12. The second air inlet 114 is located at the top of the housing 110. Both the first air inlet 112 and the second air inlet 114 are connected to the mounting space 116 and link to the air outlet 118 via the mounting space 116. And there is an air path 150 between the air outlet 118 and the second opening 14. Heat dissipation module also includes a heat sink 140 which is installed in the air passage 150. The thermal energy is carried away by using the air flowing in the air passage 150. In addition, there is a frame support 114a which is mounted in the second air inlet 114 of the housing 110. Its top view is shown in FIG. 1D. The frame support 114a with a plurality of holes 114b to allow air circulation is disposed over the second air inlet 114.

When the heat dissipation module 100 operates, the fan 120 will engulf the outside air of the casing 10 to sequentially go through the mesh 130, the first air inlet 112 and then enter the mounting space 116. In the mean time, the fan 120 will also engulf the hot air in the portable electronic device to sequentially go through the frame support 114a, the second air inlet 114 and then enter the mounting space 116. After wandering in the mounting space 216 of both the outside air and the hot air in the portable electronic device, the mixed air will sequentially go through the air outlet 118 and the second opening 14 of the portable electronic device, and then expel to the outside of the portable electronic device. This can reduce the inside temperature of the portable electronic device.

Here one thing needs to be noticed. These aforementioned holes 132 of the mesh 130 are usually designed as a slit (shown in FIG. 1B) or circle opening (shown in FIG. 1C). In order to match the safety standard of portable electronic devices, if the holes 132 of the mesh 130 is designed by slits, the width W1 of the slit is necessary to be less than or equal to 1 mm (shown in FIG. 1B). In addition, if the holes 132 of the mesh 130 is designed by circular holes, the diameter D1 of these holes 132 of the mesh 130 needs to be less than or equal to 1.5 mm (shown in FIG. 1C). However, as long as these holes 132 of the mesh 130 satisfy the safety standard regardless the slit type or circular hole, it will have not enough intake airflow at the first opening 12 of the casing 10 due to the width W1 or diameter D1 of these holes 132 being over-small. Consequently, the heat dissipation effect of the portable electronic device can not be improved.

Accordingly, the conventional heat dissipation module 100 usually uses the second air inlet 114 at the top of the housing 110 and increases the number of holes 132 on the mesh 130 to gain more intake airflow at the first opening 12 of the casing 10. It thus enhances the heat dissipation efficiency of the portable electronic device. However, since the second air inlet 114 is located at the top of the housing 110 and is close to the inner part of the portable electronic device, its ability to engulf intake airflow for the portable electronic device is limited.

In addition, this conventional heat dissipation module 100 can increase the number of these holes 132 on the mesh 130 in order to gain more intake airflow at the first opening 12 of the casing 10. This is under the comparison to the situation without increasing the number of holes 132 on the mesh 130. However, this will cause that the integral formation method cannot be used to directly form the mesh 130 on the casing 10 of the portable electronic device. Therefore the production cost of the portable electronic device cannot be decreased. Also, even though the number of these openings 132 increases, there is still not able to have enough intake airflow to the portable electronic device due to the restriction of the safety standard, causing the width W1 or diameter D1 of these openings to be too small. Similarly, the heat dissipation efficiency of the portable electronic device can not be improved.

### SUMMARY OF THE INVENTION

In view of this, an objective of the invention is to provide a heat dissipation module which is suited for portable electronic device. This can let the portable electronic device not only satisfy the safety standard but also improve its heat dissipation efficiency.

Another objective of the invention is to provide a heat dissipation module suited for portable electronic device to reduce its production cost.

In order to achieve the objectives mentioned above, this invention provides a heat dissipation module which is suited for a portable electronic device, wherein the portable electronic device includes a casing which has an opening, located at the lateral location of the casing. The heat dissipation module includes a first mesh, a housing and a fan, wherein the first mesh is disposed at the bottom of the casing. The first mesh with a plurality of first holes is formed as an integral unit with the bottom of the casing. In addition, the housing has an air inlet, a second mesh, a mounting space and an air outlet, wherein the air inlet is disposed at the bottom of the housing and faces against the first mesh. The second mesh with a plurality of second holes to allow air circulation is disposed at the top of the housing and is formed as an integral unit with the top of the housing. And the diameter of each of the second holes is smaller than the diameter of each of the first holes. Both the air inlet and these second holes of the second mesh are connected to the mounting space, and link to the air outlet via the mounting space. There is an air path between the air outlet and the opening. And the aforementioned fan is installed in the mounting space.

According to a preferred embodiment of the invention, the heat dissipation module also includes a heat sink which is installed in the air passage.

According to a preferred embodiment of the invention of the heat dissipation module, these first holes can be, for example, slit and the width of the slits is greater than 1 mm. In addition, these first holes can also be, for example, circular holes and the diameter of these holes is greater than 1.5 mm.

According to a preferred embodiment of the invention of the heat dissipation module, the second holes can be, for example, slits and the width of the slits is less than 1 mm. In addition, the second can be also be, for example, circular holes and the diameter of the holes is less than 1.5 mm.

According to a preferred embodiment of the invention of the heat dissipation module, wherein the method to form the first mesh and the bottom of the casing together as an integral unit can include injection molding process. In addition, the method to form the second mesh and the top of the housing together as an integral unit can include injection molding process.

According to a preferred embodiment of the invention of the heat dissipation module, the rotation axis direction of the fan is substantially parallel to the center axis of the air inlet of the housing and the second mesh. Whereas, the center axis of the air inlet and the second mesh is substantially perpendicular to the center axis of the air outlet.

As mentioned above, the invention of the heat dissipation module is to install a second mesh, which satisfies the safety standard, at the top of the housing. And a first mesh is installed at the bottom of the casing of the portable electronic device, wherein the first mesh does not need to satisfy the size restriction of the safety standard. Thus the width or diameter of these holes on the first mesh can be relatively greater than those on the second mesh. This can allow the portable electronic device not only to satisfy the safety standard but also to enhance its heat dissipation efficiency. In addition, the first mesh and the second mesh are respectively formed together with the bottom of the casing and the top of the housing as an integral unit to reduce the production cost of the portable electronic device.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a cross-sectional drawing showing a conventional heat dissipation module in a portable electronic device.

FIG. 1B is a bottom view of the mesh, showing slits in FIG. 1A.

FIG. 1C is a bottom view of the mesh, showing circular holes in FIG. 1A.

FIG. 1D is a top view of the frame support shown in FIG. 1A.

FIG. 2A is a cross-sectional drawing, schematically showing a heat dissipation module in a portable electronic device according to a preferred embodiment of the invention.

FIG. 2B is a top view of the first mesh shown in FIG. 2A.

FIG. 2C is a bottom view of the second mesh, schematically showing slits in FIG. 2A.

FIG. 2D is a bottom view of the second mesh, schematically showing circular holes in FIG. 2A.

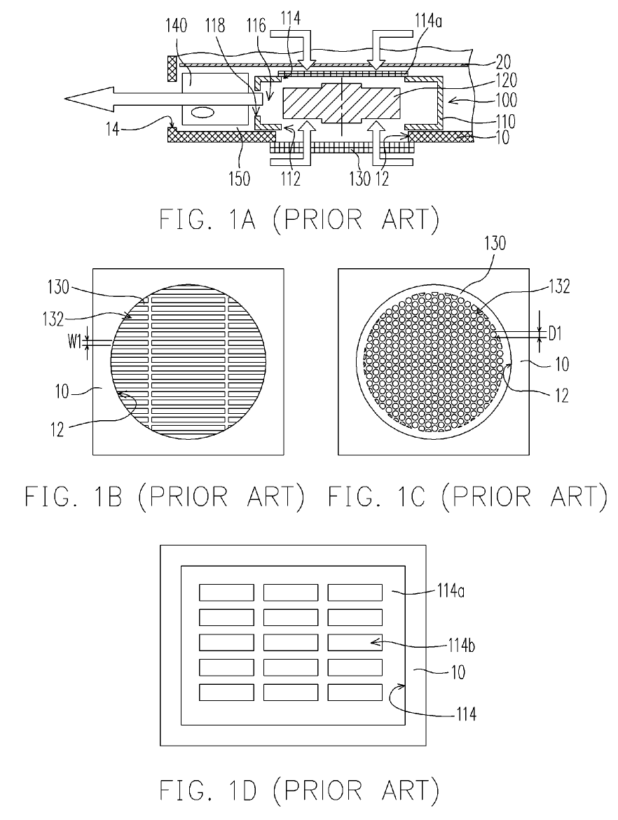

### DESCRIPTION OF THE PREFERRED EMBODIMENTS

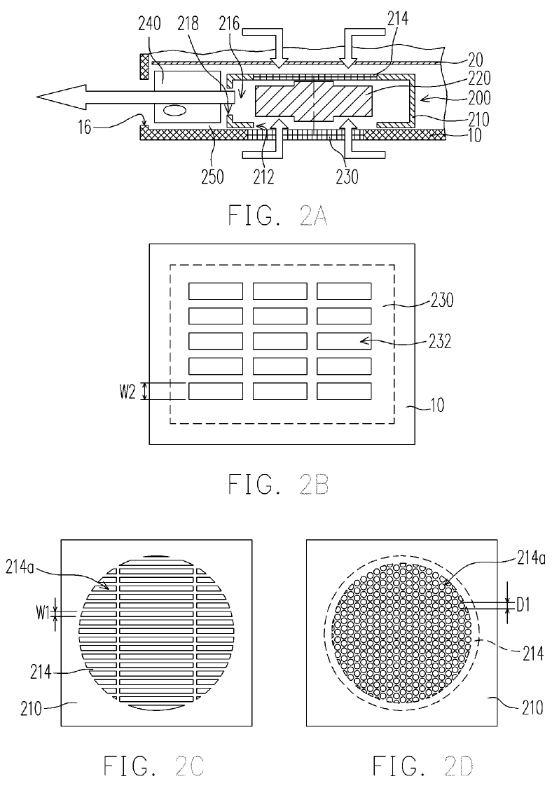

Referring to FIG. 2A, it is a cross-sectional drawing, schematically illustrating a heat dissipation module suited for a portable electronic device, according to a preferred embodiment of the invention. The heat dissipation module 200 is suited for a portable electronic device, such as notebook. This portable electronic device includes a main module (not shown) and a casing 10. The main module has a motherboard 20 which is installed in the casing 10. In addition, the casing 10 has an opening 16 which is at lateral location of the casing 10 to lead the air out.

The aforementioned heat dissipation module 200 includes a housing 210 and a fan 220, wherein the fan 220 is installed inside the housing 210. The rotation axis direction of the fan 220 is substantially parallel to the center axis of the air inlet 212 of the housing 210 and the second mesh 214, and substantially perpendicular to the center axis of the air outlet 218.

In addition, referring to FIG. 2A and 2B, wherein FIG. 2B is the top view of the first mesh 230. The heat dissipation module 200 also includes a first mesh 230, wherein the first mesh 230 is located in the first opening 12 at the bottom of the casing 10 and is formed together with the bottom of the casing 10 as an integral unit. And the method to form the first mesh 230 and the bottom of the casing 10 together as an integral unit is, for example, by injection molding process. In addition, the first mesh 230 could have a plurality of holes 232 to allow air circulation. These holes 232 can be slits and their width W2 can be greater than 1 mm. One thing needs to be mentioned here. Although the preferred embodiments of this invention shows that the holes 232 are slits, these holes 232 can also be circular holes (not shown) without departing from the scope or spirit of the invention. When these holes 232 are circular holes, the diameter D1 can be greater than 1.5 mm.

The housing 210 is installed inside the casing 10, which has an air inlet 212, a second mesh 214, a mounting space 216 and an air outlet 218. The aforementioned fan 220 is installed in the mounting space 216. The air inlet 212 is located at the bottom of the housing 210, and faces against the first mesh 230. The second mesh 214 is located at the top of the housing 210 and is formed together with the top of the housing 210 as an integral unit, wherein the method to form the second mesh 214 and the top of the housing 210 together as an integral unit is, for example, by injection molding process. In addition, the second mesh 214 has a plurality of holes 214a. These holes 214a can be slits (shown in FIG. 2C) or circular hole (shown in FIG. 2D) to allow air circulation. Remarkably, in order to satisfy the safety standard of the portable electronic device, the width W1 of these openings 214a needs to be less than or equal to 1 mm when these holes 214a are slits, as shown in FIG. 2C. In addition, the diameter D1 of these holes 214a needs to be less than or equal to 1.5 mm when these openings 214a are circular holes, as shown in FIG. 2D.

In addition, the aforementioned air inlet 212 and these holes 214a of the second mesh 214 are connected to the mounting space 216, and link to the air outlet 218 via the mounting space 216. And there is an air path 250 between the air outlet 218 and the opening 16. One thing needs to be mentioned here. The heat dissipation module 200 can further include a heat sink 240 which is installed in the air path 250. The air flows in the air path 250 and thereby caries the heat energy away.

When the heat dissipation module 200 operates, the fan 220 will automatically engulf the outside air of the casing 10 to sequentially go through the first mesh 230 and the air inlet 212, and then enter into the mounting space 216. In the mean time, the fan 220 will also engulf the hot air in the portable electronic device to enter the mounting space 216 via the second mesh 214. After wandering in the mounting space 216 of both the outside air from the casing 10 and the hot air in the portable electronic device, the mixed air will consecutively go through the air outlet 218, the second opening 14 of the casing 10, and then expel to the outside of the portable electronic device. This can reduce the inside temperature of the portable electronic device.

Remarkably, since these holes 214a of the second mesh 214 of the housing 210 have already satisfied the safety standard of the portable electronic device, the width W2 of these holes 232 on the first mesh 230 of the casing 10 does not need to be less than or equal to 1 mm anymore. It means that the width W2 of these holes 232 on the first mesh 230 can be greater than 1 mm. Therefore, more intake airflow from the outside of the casing 10 can be engulfed into the portable electronic device. The heat dissipation efficiency of the portable electronic device can then be improved. One thing needs to be noticed here: The invention of the heat dissipation module 200 is suited for the portable electronic device, but not limited to the notebook. This invention can also be, for example, suited for the tablet PC and other portable electronic devices.

In conclusion, the invention of the heat dissipation module is to install a second mesh at the top of housing which satisfies the safety standard, and install a first mesh at the bottom of casing of the portable electronic device. Since the size of the opening of the second mesh has already satisfied the safety standard, the size of the opening of the first mesh does not need to satisfy the safety standard. Therefore the size of these holes of the first mesh will be greater than that of these holes of the second mesh. Because of this, the invention can let the portable electronic device satisfy the safety standard but also increase the intake airflow of the portable electronic device to improve the heat dissipation efficiency of the portable electronic device, accordingly. In addition, the first mesh and the second mesh of the invention of the heat dissipation module are respectively formed with the bottom of the casing and the top of the housing together as an integral unit to effectively reduce the production cost of the portable electronic device.

Although a preferred embodiment has been described above to explain this invention, it does not limit to this invention. It will be apparent to those skilled in the art that various modifications and variations can be made to the structure of the present invention without departing from the scope or spirit of it. In view of the foregoing, it is intended that the present invention cover modifications and variations of this invention provided they fall within the scope of the following claims and their equivalents.

What is claimed is:

1. A heat dissipation module, suitable for a portable electronic device, wherein a casing of the portable electronic device has an opening, and the opening is at a lateral location of the casing, the heat dissipation module comprising:
a first mesh, installed at a bottom of the casing, wherein the first mesh with a plurality of first holes and the bottom of the casing are formed together as an integral unit to allow air circulation;
a housing, installed in the casing, the housing having an air inlet, a second mesh, a mounting space, and an air outlet, wherein the air inlet is disposed at a bottom of the housing and faces against the first mesh, the second mesh is disposed at a top of the housing and is formed as an integral unit, the second mesh has a plurality of second holes to allow air circulation, wherein a diameter of the second holes is smaller than a diameter of the first openings, and both the air inlet and the second holes of the second mesh are connected to the mounting space, and link to the air outlet via the mounting space, wherein an air path is between the air outlet and the opening; and
a fan, installed in the mounting space of the housing.

2. The heat dissipation module as claimed in claim 1, further comprising a heat sink, installed in the air path.

3. The heat dissipation module as claimed in claim 1, wherein the first holes are slits.

4. The heat dissipation module as claimed in claim 3, wherein a width of these first holes is greater than 1 mm.

5. The heat dissipation module as claimed in claim 1, wherein the first holes are circular holes.

6. The heat dissipation module as claimed in claim 5, wherein a diameter of the first holes is greater than 1.5 mm.

7. The heat dissipation module as claimed in claim 1, wherein the second holes are slits.

8. The heat dissipation module as claimed in claim 7, wherein a width of these second holes is less than or equal to 1 mm.

9. The heat dissipation module as claimed in claim 1, wherein the second holes are circular holes.

10. The heat dissipation module as claimed in claim 9, wherein a diameter of the second holes is less than or equal to 1.5 mm.

11. A portable electronic device, comprising:
a main module;
a casing, containing the main module, having an opening located at a lateral location of the casing;
a first mesh, installed at a bottom of the casing, wherein the first mesh with a plurality of first holes and the bottom of the casing are formed together as an integral unit, and the first holes allow air circulation;
a housing, installed in the casing, wherein the housing has an air inlet, a second mesh, a mounting space and an air outlet, wherein the air inlet is disposed at a bottom of the housing and faces against the first mesh, the second mesh with a plurality of second holes is disposed at a top of the housing, and is formed as an integral unit with the top of the housing, the second holes allow air circulation, wherein a diameter of the second holes is smaller than a diameter of the first holes, both the air inlet and the second holes of the second mesh are connected to the mounting space, and link to the air outlet via the mounting space, wherein an air path is between the air outlet and the vent; and
a fan, installed in the mounting space of the housing.

12. The portable electronic device as claimed in claim 11, wherein the portable electronic device is a notebook.

13. The portable electronic device as claimed in claim 11, wherein the first holes are slits.

14. The portable electronic device as claimed in claim 13, wherein a width of these first holes is greater than 1 mm.

15. The portable electronic device as claimed in claim 11, wherein the first holes are circular holes.

16. The portable electronic device as claimed in claim 15, a diameter of these first holes is greater than 1.5 mm.

17. The portable electronic device as claimed in claim 11, wherein the second holes are slits.

18. The portable electronic device as claimed in claim 17, a width of these second holes is less than or equal to 1 mm.

19. The portable electronic device as claimed in claim 11, wherein the second holes are circular holes.

20. The portable electronic device as claimed in claim 19, wherein a diameter of these second holes is less than or equal to 1.5 mm.
